(19) United States
(12) Patent Application Publication
(10) Pub. No.: US 2007/0201838 A1
(43) Pub. Date: Aug. 30, 2007

(54) Recording and reproducing apparatus

(76) Inventors: Kazuhide Yanase, Osaka (JP); Yukari Baba, Osaka (JP)

Correspondence Address: MCDERMOTT WILL & EMERY LLP, 600 13TH STREET, NW, WASHINGTON, DC, 20005-3096, US

(21) Appl. No.: 11/709,730

(22) Filed: Feb. 23, 2007

(30) Foreign Application Priority Data
Feb. 23, 2006 (JP) 2006-046518

(51) Int. Cl. H04N 7/26

(52) U.S. Cl. 386/112

(57) ABSTRACT

In the recording and reproducing apparatus, managing information and recovering data for a TS packet is inserted in the TS packet of a recording-target transport stream, and the TS packet is recorded on a recording medium. At the time of reproducing action performed after recording halt processing is not properly ended, the recovering data is extracted from the TS packet that is read out from the recording medium. The managing information is recovered from the recovering data that has been extracted. The TS packet is reproduced from the recording medium based on the managing information that has been recovered.

### BACKGROUND OF THE INVENTION

1. Field of the Invention

The present invention relates to a recording and reproducing apparatus that uses a hard disk or an optical disk as the recording medium. More specifically, the present invention relates to a technique for correcting inconsistency between a transport stream and managing information at the time of recording action and editing action, which is caused by improper ending of the system.

2. Description of the Related Art

In a recording and reproducing apparatus that records the transport stream of MPEG digital video contents in real time, e.g. ADD, DVD (digital versatile disc), vacant areas are searched when recording the video data on the recording medium, and the video data is recorded therein discontinuously, unlike in the case of using a video tape recorder. Thus, there is required the managing information for managing addresses of the video data that is recorded on the recording medium.

For this, when recording the video data, the managing information is updated every time a specific amount of video data is recorded on a recording medium, and the updated managing information is written into the recording medium at the point where the recording is completed.

Normally, in the recording medium during a recording action, there is no consistency between the transport stream being recorded and the managing information. Therefore, in the case where the recording halt processing is not completed properly due to a power outage or a system failure caused during the recording processing, the inconsistency between the data on the recording medium is to be maintained. In that case, it is possible that the inconsistency may affect reproducing processing, editing processing, and post-writing processing performed thereafter.

As a measure for that issue, there is a conventional technique as disclosed in a Japanese disclosed patent literature (Japanese Unexamined Patent Publication 2002-84498), which provides a recording and reproducing apparatus with a nonvolatile memory for recording recovering data that is required for recovering from the abnormality when the recording action is improperly ended, and generates the recovering data at the time of recording to store it in the nonvolatile memory. When there is an improper recording action, the recovering data is read out from the nonvolatile memory to recover the managing information.

Further, there is also a conventional technique which, as shown in FIG. 24, interleaves a storage area for the recovering data in a video/audio recording area within the same recording medium, and reads out the recovering data from the recording medium at the time of improper recording action to recover the managing information. This technique is disclosed in a Japanese disclosed patent literature (Japanese Unexamined Patent Publication 2004-178788), for example.

However, the conventional structures described above require the nonvolatile memory for recording the recovering data, so that the cost of the device is high. Further, when the storage area for the recovering data is interleaved in the video/audio recording area within the same recording medium, the area for the video/audio becomes smaller.

### SUMMARY OF THE INVENTION

The main object of the present invention therefore is to utilize a recording medium without waste, omit the nonvolatile memory, and cut the cost of the components of the system.

In order to achieve the aforementioned object, in a recording and reproducing apparatus of the present invention, managing information and recovering data for a TS packet is inserted in the TS packet of a recording-target transport stream, and the TS packet is recorded on a recording medium; and
at a time of reproducing action performed after recording halt processing is not properly ended, the recovering data is extracted from a TS packet that is read out from the recording medium, the managing information is recovered from the recovering data that has been extracted, and the TS packet is reproduced from the recording medium based on the managing information that has been recovered.

Specifically, the recording and reproducing apparatus of the present invention comprises:
a recovering data generating section for generating the recovering data at a time of recording action;
a recording control section which generates the managing information of the TS packet of the recording-target transport stream, inserts the recovering data in the TS packet, and records a recovering-data inserted TS packet on the recording medium along with the managing information;
a recording improper-ending detecting section which, upon detecting that recording halt processing is not properly ended, sends out a recording improper-ending notification to the recording control section; and
a reproducing control section which reads out the managing information from the recording medium, and reproduces the TS packet by making an access to the recording medium based on the managing information, wherein
upon receiving the recording improper-ending notification from the recording improper-ending detecting section, the reproducing control section reads out the recovering-data inserted TS packet from the recording medium and extracts the recovering data from the TS packet, recovers the managing information from the recovering data that has been extracted, and reproduces the TS packet from the recording medium based on the managing information that has been recovered.

With this structure, the recording improper-ending detecting section notifies an occurrence of recording improper-ending to the reproducing control section, when there is a power outage or a system failure during the recording action and the recording halt processing is not completed properly. The reproducing control section saves the recording improper-ending notification received at the time of recording action. At the time of reproducing action, the reproducing control section reads out the recovering-data inserted TS packet and the managing information from the recording medium, and reproduces the TS packet by making an access to the recording medium based on the managing information. If the recording improper-ending notification is saved at that time, it can be considered that the TS packet and the managing information are not consistent. Thus, for reproducing the TS packet, the reproducing control section recovers the managing information by using the recovering data that is recorded in the TS packet, and then reproduces the TS packet from the recording medium by making an access to the recording medium based on the recovered managing information.

For recording the recovering data, in the conventional technique, the recovering data is recorded in an exclusive recovering data recording area that is different from the nonvolatile memory and the video/audio recording area. However, in the present invention, the recovering data is recorded in the TS packet (preferably, the stuffing byte area). Thus, the recovering data can be stored in the recording medium integrally with the TS packet. The stuffing byte area that is optimum for recording the recovering data is a dummy area in the TS packet in principle, so that the recording medium can be utilized without waste. Therefore, it is unnecessary to use a nonvolatile memory, and the cost of the components of the system can be reduced.

In another embodiment of the present invention, the recording and reproducing apparatus in the above-described structure further comprises a specific PID detecting section for detecting a preset specific PID from the recording-target transport stream, wherein
upon receiving a detection notification of the specific PID from the PID detecting section, the recording control section generates divided data that is obtained by dividing the recovering data into a plurality of pieces, individually inserts the divided data to a plurality of specific TS packets that correspond to the specific PID, and records divided-data inserted specific TS packets on the recording medium along with the managing information.

With such structure, it is possible to individually insert the divided data that is obtained by dividing the recovering data into a plurality of pieces in the plurality of TS packets with the specific PID, and record the TS packets on the recording medium.

Further, in another embodiment of the present invention, in the recording and reproducing apparatus in the above-described structure, upon receiving the recording improper-ending notification from the recording improper-ending detecting section, the specific PID detecting section detects the specific PID from the transport stream that is read out from the recording medium;
at a time of reproducing action performed after receiving the recording improper-ending notification, the recovering data generating section extracts the divided data from each of the plurality of TS packets that correspond to the specific PID, and recovers the recovering data by combining a plurality of pieces of the divided data that have been extracted; and
the reproducing control section recovers the managing information by using the recovering data that has been recovered.

With such structure, the data in the TS packets, which has been replaced with the divided data, can be restored in its original state, since the recovering data is recovered by combining the divided data recorded on the plurality of TS packets that correspond to the specific PID in the transport stream.

Furthermore, in another embodiment of the present invention, the recording and reproducing apparatus in the above-described structure further comprises a payload unchanged PID detecting section which detects, in the recording-target transport stream, a payload unchanged PID that corresponds to a TS packet whose payload is unchanged, wherein
upon receiving a detection notification of the payload unchanged PID from the payload unchanged PD detecting section, the recording control section generates divided data that is obtained by dividing the recovering data into a plurality of pieces, individually inserts the divided data to each payload of a plurality of the specific TS packets that correspond to the payload unchanged PID, and records divided-data inserted specific TS packets on the recording medium along with the managing information.

With such structure, it is possible to individually insert the divided data in each payload of the plurality of TS packets that correspond to the payload unchanged PID, and record the TS packets on the recording medium.

Moreover, in another embodiment of the present invention, the recording and reproducing apparatus in the above-described structure further comprises a divided-data inserted PID detecting section which detects, in a transport stream that is reproduced from the recording medium, divided-data inserted PIDs that correspond to the divided-data inserted TS packets, wherein
upon receiving the recording improper-ending notification from the recording improper-ending detecting section, the recovering data generating section extracts the divided data from each of the payloads of the TS packets that correspond to the divided-data inserted PIDs detected by the divided-data inserted PID detecting section, and recovers the recovering data from a plurality of pieces of the divided data that have been extracted.

With such structure, it is possible to recover the recovering data from the divided data recorded in the payloads of the transport stream, and to restore the data of the payload, which has been replaced with the divided data, in its original state.

Further, there is also such a form that the recording and reproducing apparatus in the above-described structure further comprises a new PID finding section which finds a new PID that is not currently present in the recording-target transport stream, wherein
upon receiving a detection notification of the new PID from the new PID finding section, the recording control section generates divided data that is obtained by dividing the recovering data into a plurality of pieces, individually inserts the divided data to each payload of a plurality of the specific TS packets that correspond to the new PID, and records divided-data inserted specific TS packets on the recording medium along with the managing information.

With such structure, it is possible to generate the TS packets with a new PID that is not present in the transport stream, and the TS packets in which the divided data is inserted can be recorded to the recording medium.

Furthermore, in another embodiment of the present invention, the recording and reproducing apparatus in the above-described structure further comprises a new PID detecting section which detects the new PID in a transport stream that is reproduced from the recording medium, wherein
upon receiving the recording improper-ending notification, the recovering data generating section extracts the divided data from the payloads of each TS packet that correspond to the new PID detected by the new PID detecting section, and recovers the recovering data from a plurality of pieces of the divided data that have been extracted.

With such structure, it is possible to recover the recovering data from the divided data recorded on the TS packets that correspond to the new PID, and then to cancel the new PID in which the divided data has been stored.

Regarding where to record the recovering data, in the conventional technique, the recovering data is recorded in an exclusive recovering data recording area that is different from the nonvolatile memory and the video/audio recording area. However, in the present invention, the recovering data is inserted in the TS packet, and the recovering-data inserted TS packet is recorded on the recording medium. Thus, the recovering data can be stored in the recording medium integrally with the TS packet. Further, the recording medium can be utilized without waste. In addition, it is unnecessary to use a nonvolatile memory, and the cost of the components of the system can be reduced.

The recording and reproducing apparatus of the present invention is most effective to be utilized as the products in the field of household AV appliances in particular. Since the number of necessary components can be reduced, the effect of cost reduction in mass production is significant. Furthermore, data reproducibility by the recovering processing after the occurrence of improper-ending is high, which leads to improving the convenience.

### BRIEF DESCRIPTION OF THE DRAWINGS

Other objects of the present invention will become clear from the following description of the preferred embodiments and the appended claims. Those skilled in the art will appreciate that there are many other advantages of the present invention possible by embodying the present invention.

FIG. 1 is a block diagram for showing the structure of a recording and reproducing apparatus according to a first embodiment of the present invention;

FIG. 2 is a sequence chart for showing the action of the recording and reproducing apparatus according to the first embodiment of the present invention;

FIG. 3 is an illustration for describing an action mode of the recording and reproducing apparatus according to the first embodiment of the present invention;

FIG. 4 is a block diagram for showing the structure of a recording and reproducing apparatus according to a second embodiment and a fourth embodiment of the present invention;

FIG. 5 is a sequence chart for showing the action of the recording and reproducing apparatus according to the second embodiment of the present invention;

FIG. 6 is an illustration for describing an action mode of the recording and reproducing apparatus according to the second and third embodiments of the present invention;

FIG. 7 is a block diagram for showing the structure of a recording and reproducing apparatus according to the third embodiment of the present invention;

FIG. 8 is a sequence chart for showing the action of the recording and reproducing apparatus according to the third embodiment of the present invention;

FIG. 9 is a sequence chart for showing the action of a recording and reproducing apparatus according to a fourth embodiment of the present invention;

FIG. 10 is an illustration for describing an action mode of the recording and reproducing apparatus according to the fourth and fifth embodiments of the present invention;

FIG. 11 is a sequence chart for showing the action of the recording and reproducing apparatus according to the fifth embodiment of the present invention;

FIG. 12 is a block diagram for showing the structure of a recording and reproducing apparatus according to a sixth embodiment of the present invention;

FIG. 13 is a sequence chart for showing the action of the recording and reproducing apparatus according to the sixth embodiment of the present invention;

FIG. 14 is an illustration for describing an action mode of the recording and reproducing apparatus according to the sixth embodiment of the present invention;

FIG. 15 is a block diagram for showing the structure of a recording and reproducing apparatus according to a seventh embodiment of the present invention;

FIG. 16 is a sequence chart for showing the action of the recording and reproducing apparatus according to the seventh embodiment of the present invention;

FIG. 17 is an illustration for describing an action mode of the recording and reproducing apparatus according to the seventh embodiment of the present invention;

FIG. 18 is a block diagram for showing the structure of a recording and reproducing apparatus according to an eighth embodiment of the present invention;

FIG. 19 is a sequence chart for showing the action of the recording and reproducing apparatus according to the eighth embodiment of the present invention;

FIG. 20 is a first illustration for describing an action mode of the recording and reproducing apparatus according to the eighth embodiment and a ninth embodiment of the present invention;

FIG. 21 is a second illustration for describing an action mode of the recording and reproducing apparatus according to the eighth and ninth embodiments of the present invention;

FIG. 22 is a block diagram for showing the structure of a recording and reproducing apparatus according to the ninth embodiment of the present invention;

FIG. 23 is a sequence chart for showing the action of the recording and reproducing apparatus according to the ninth embodiment of the present invention; and

FIG. 24 is an illustration for describing the issue that is to be overcome by the present invention.

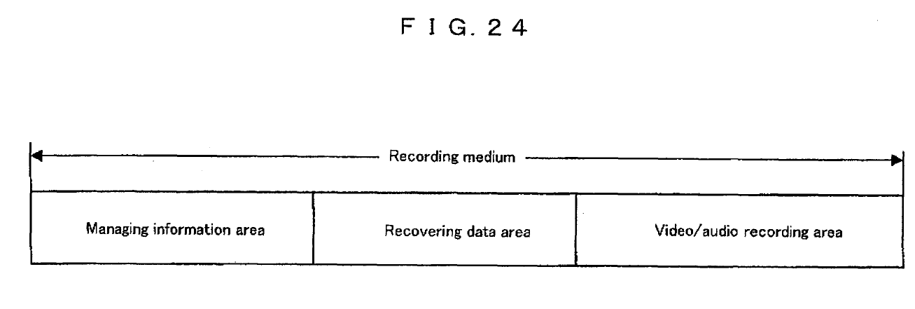

### DETAILED DESCRIPTION OF THE INVENTION

Preferred embodiments of the present invention will be described hereinafter by referring to the accompanying drawings.

### First Embodiment

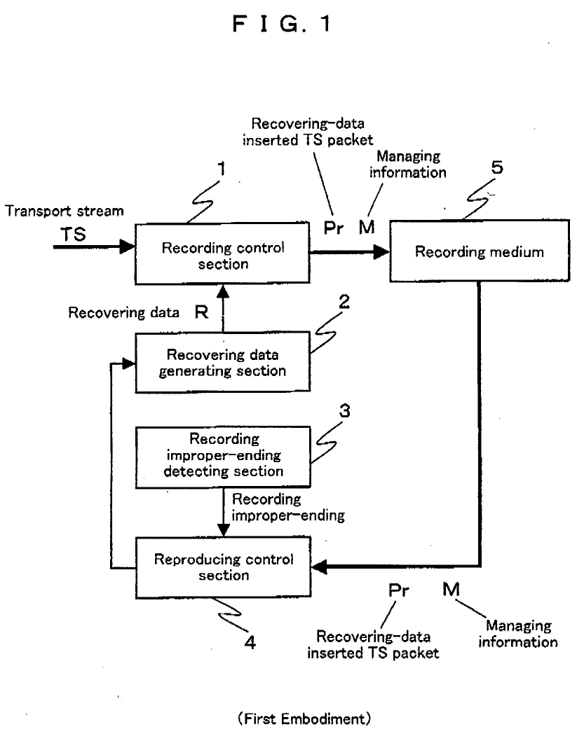

FIG. 1 is a block diagram for showing the structure of a recording and reproducing apparatus according to a first embodiment of the present invention. In this embodiment, recovering data is inserted in the stuffing byte area of a TS packet in advance at the time of recording action, and the TS packet is recorded on a recording medium. Then, managing information is recovered by using the recovering data when reproducing the TS packet that is related to an improper recording action.

In FIG. 1, reference numeral 1 is a recording control section and 2 is a recovering data generating section. Reference numeral 3 is a recording improper-ending detecting section, 4 is a reproducing control section, and 5 is a recording medium such as a hard disk, a DVD-RAM, etc.

The recording control section 1 receives the MPEG transport stream TS inputted from outside, and generates managing information M that corresponds to TS packet P of the transport stream TS. Then, the recording control section 1 records the TS packet P and the managing information M on the recording medium 5.

The recovering data generating section 2 generates the recovering data R at the time of recording action and sends it to the recording control section 1. The recording control section 1 inserts the recovering data received from the recovering data generating section 2 in the TS packet, and records the TS packet Pr, in which the recovering data R is inserted, on the recording medium 5 along with the managing information M. The recovering data R is the data required for recovering from the abnormality of the recording, which is provided as a preliminary measure for the case where the recoding is improperly ended. The managing information M is the information that is required when reproducing the TS packet P recorded in the recording medium 5.

The recording improper-ending detecting section 3 notifies an occurrence of recording improper-ending, when there is a power outage or a system failure during the recording action and the recording halt processing is not completed properly. Specifically, upon detecting an occurrence of improper ending at the time of recording action, the recording improper-ending detecting section 3 sends a notification of the recording improper-ending to the reproducing control section 4.

The reproducing control section 4 reads out the TS packet P and the managing information M from the recording medium 5, and reproduces the TS packet P by making an access to the recording medium 5 based on the managing information M. The reproducing control section 4 saves the recoding improper-ending notification received from the recording improper-ending detecting section 3, and checks at the time of reproducing action whether or not the recoding improper-ending notification is saved. Upon confirming that the recoding improper-ending notification is saved, the reproducing control section 4 considers that the consistency between the TS packet P and the managing information M is inappropriate, and performs the next action. That is, in this case, the reproducing control section 4 extracts the recovering data R recorded in the stuffing byte area of the TS packet Pr in which the recovering data R read out from the recording medium 5 has been inserted, and recovers the managing information M by using the extracted recovering data R. The reproducing control section 4 makes an access to the recording medium 5 based on the recovered managing information M, and reproduces the TS packet P from the recording medium 5.

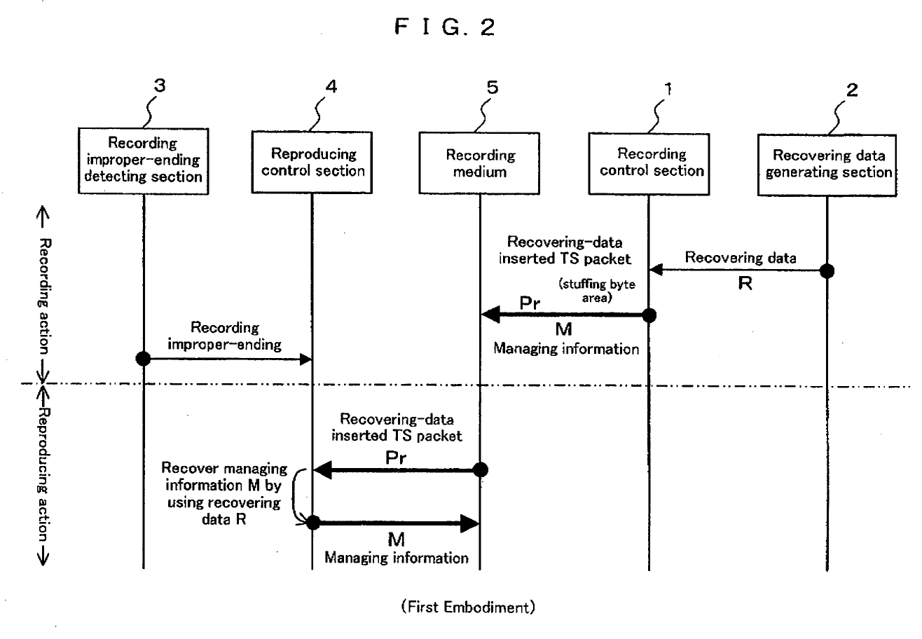

Next, there will be described the action of the recording and reproducing apparatus according to the embodiment structured in the manner described above, by referring to a sequence chart shown in FIG. 2. First, the action at the time of recording will be described.

When the MPG transport stream TS is inputted from outside, the recording control section 1 generates the managing information M of the TS packet P contained in the transport stream TS, and records the TS packet P and the managing information M on the recording medium 5. In this state, the recovering data generating section 2 is also in action, which generates the recovering data R that corresponds to the TS packet P and sends it out to the recoding control section 1. The recording control section 1 inserts the recovering data R received from the recovering data generating section 2 in the stuffing byte area that is a dummy area in the TS packet P, and records the TS packet Pr, in which the recovering data R has been inserted, on the recording medium 5 along with the managing information M.

Under the state where a power outage or a system failure occurs during the recording action and the recording halt processing is not completed properly, the recording improper-ending detecting section 3 starts the action. The recording improper-ending detecting section 3 detects the occurrence of abnormality, generates a recording improper-ending notification, and sends it out to the reproducing control section 4. The reproducing control section 4 saves the received recording improper-ending notification.

Next, the action at the time of reproduction will be described. At the time of reproducing action, the reproducing control section 4 reads out the TS packet Pr, in which the recovering data P has been inserted, and the managing information M from the recording medium 5. Then, the reproducing control section 4 makes an access to the recording medium 5 based on the managing information M to reproduce the TS packet P from the recording medium 5.

At the time of reproducing action described above, the reproducing control section 4 checks whether or not the recording improper-ending notification is saved. When confirming that the recording improper-ending notification is saved, the reproducing control section 4 judges that the TS packet P and the managing information M are not consistent. Upon judging it, the reproducing control section 4 recovers the managing information M by using the recovering data R that is recorded in the stuffing byte area of the TS packet Pr, when reproducing the TS packet. The reproducing control section 4 makes an access to the recording medium 5 based on the recovered managing information M, and reproduces the TS packet P from the recording medium 5.

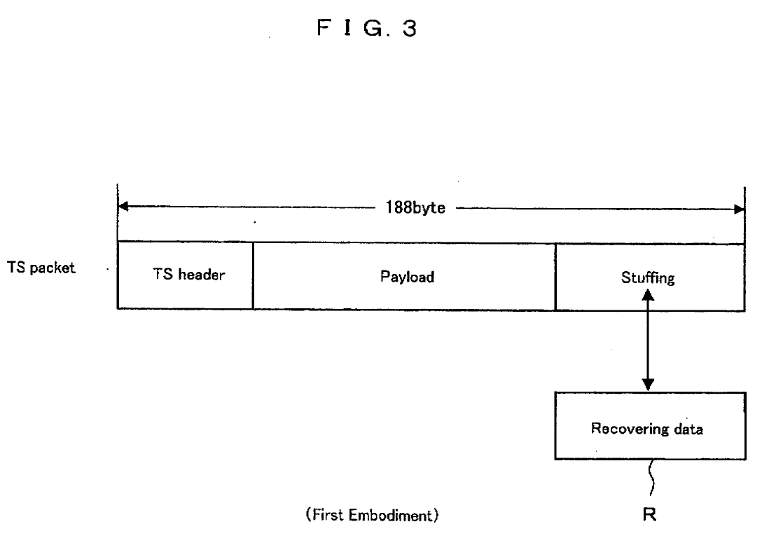

FIG. 3 shows a mode of the action. The TS packet is constituted with each area of a TS header, a payload for recording contents of video/audio data, and a stuffing byte. The recovering data R is to be inserted in the stuffing byte area.

Regarding the structure described above, the conventional technique records the recovering data R in an exclusive recovering data recording area that is different from the nonvolatile memory or the video/audio recording area. However, the embodiment inserts the recovering data R in the stuffing byte area of the TS packet P, and records the TS packet Pr, in which the recovering data has been inserted, on the recording medium 5. That is, in the embodiment, the recovering data R is recorded on the recording medium 5 integrally with the TS packet P. The stuffing byte area is a dummy area of the TS packet P in principle, so that the recording medium 5 can be utilized without waste. Thus, it is not necessary with this embodiment to provide a nonvolatile memory additionally for storing the recovering data R. Therefore, the cost of the components of the system can be reduced.

As described above, it is possible with the embodiment to store the recovering data R and recover the managing information M based on the stored recovering data R when it is required (when the recording improper-ending occurs) without securing an exclusive recording area for the recovering data R in addition to the video/audio recording area and without providing a nonvolatile memory on the outside for the recovering data R.

### Second Embodiment

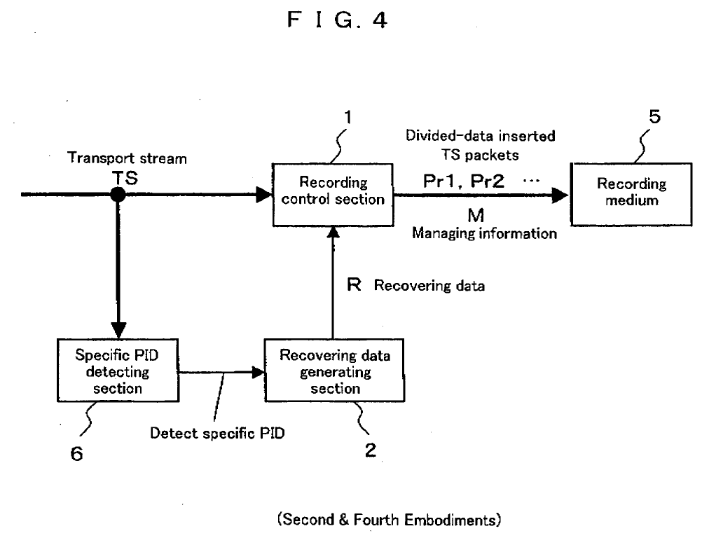

FIG. 4 is a block diagram for showing the structure of the recording and reproducing apparatus according to a second embodiment of the present invention. In this embodiment, the recovering data is divided into a plurality of pieces. Each of the divided data is individually inserted in the stuffing byte areas of a plurality of TS packets of specific PID, and the TS packets are recorded on a recording medium.

In FIG. 4, reference numeral 6 is a specific PID detecting section. The specific PID detecting section 6 detects a specific PID (packet identification) of the inputted transport stream. Reference numeral 1 is a recording control section similar to that of the first embodiment, and 2 is a recovering data generating section similar to that of the first embodiment. However, upon receiving a notification of detecting a specific PID, the recording control section 1 of this embodiment divides the recovering data R received from the recovering data generating section 2 into a plurality of pieces, and individually inserts the divided recovering data (referred to as divided data R1, R2, - - - hereinafter) in each stuffing byte area of a plurality of TS packets P1, P2, - - - , which corresponds to a single specific PID. In the drawing, the TS packets to which the divided data R1, R2, - - - are inserted are referred to as Pr1, Pr2, - - - .

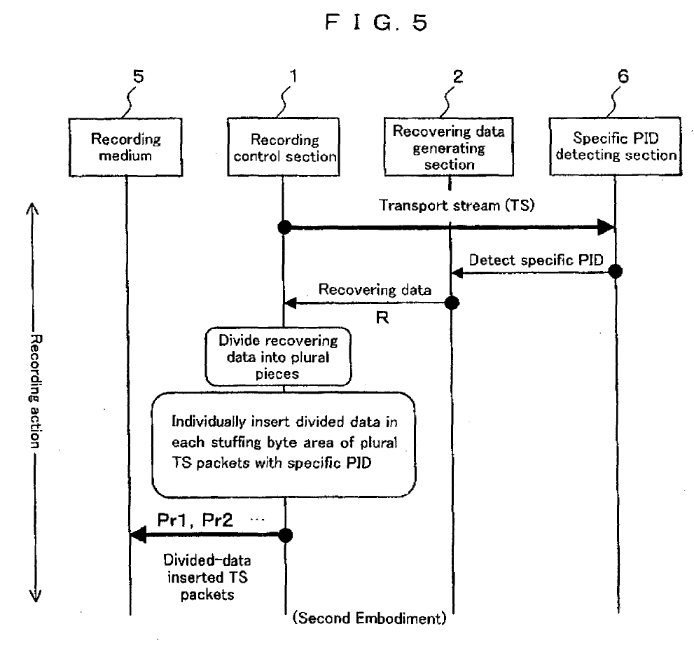

Next, the action of the recording and reproducing apparatus according to the embodiment will be described by referring to a sequence chart shown in FIG. 5. The recording control section 1 generates the managing information M that corresponds to each of the TS packets P of the transport stream TS that is inputted from the outside.

The specific PID detecting section 6 performs a detecting action for a specific PID in the transport stream TS that is inputted into the recording control section 1. If a specific PID is detected, the specific PID detecting section 6 generates a detection report and sends it out to the recording control section 1 through the recovering data generating section 2. The specific PID herein means a single PID that is specified in advance as a storage packet for the divided data. As a preliminary measure for the case where the recording action is improperly ended, the recovering data generating section 2 generates the recovering data R that is required for recovering from the abnormality, and sends it out to the recording control section 1.

Regarding the TS packet P with the PID detected as the specific PID, the recording control section 1 generates the divided data R1, R2, - - - by dividing the recovering data R received from the recovering data generating section 2 into a plurality of pieces. Further, the recording control section 1 individually inserts the generated divided data R1, R2, - - - to each of the stuffing byte areas in a plurality of TS packets P1, P2, - - - , which correspond to the specific PID. Furthermore, the recording control section 1 records the TS packets Pr1, Pr2, - - - in which the divided data has been inserted) on the recording medium 5 in order along with the respective managing information M. The divided data is not inserted in the TS packet with the PID that is not detected as the specific PID.

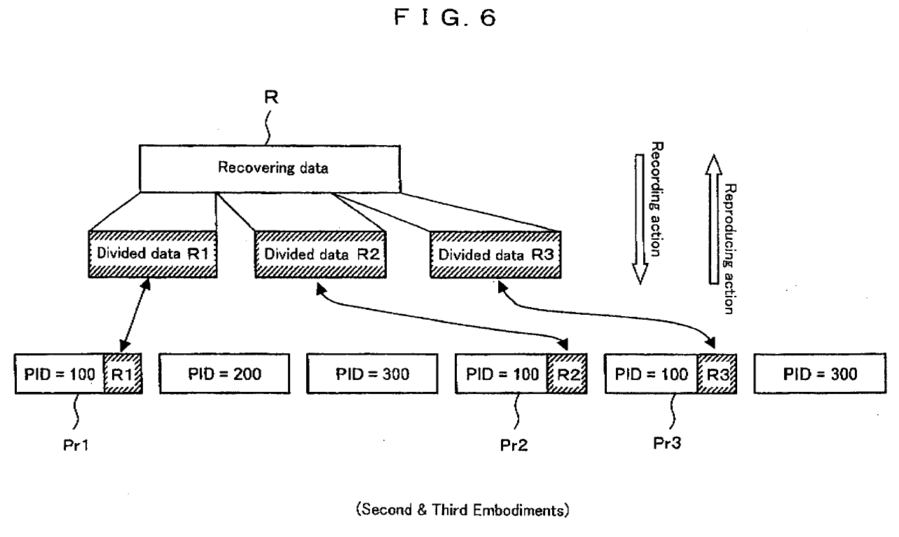

FIG. 6 shows a mode of the action. The divided data R1, R2, - - - obtained by dividing the recovering data R into a plurality of pieces are inserted in the stuffing byte areas of a plurality of TS packets Pr1, Pr2, - - - with the specific PID (PID=100).

As described above, it is possible with the embodiment to individually insert the divided data, which is obtained by dividing the recovering data into a plurality of pieces, in each of the stuffing bytes of a plurality of the TS packets that correspond to a single specific PID, and records those on the recording medium 5 in order. Needless to say, like with the first embodiment, it is also possible with the second embodiment to achieve such effects that it requires no nonvolatile memory, is capable of promoting cost reduction, and is capable of utilizing the recording medium without waste.

### Third Embodiment

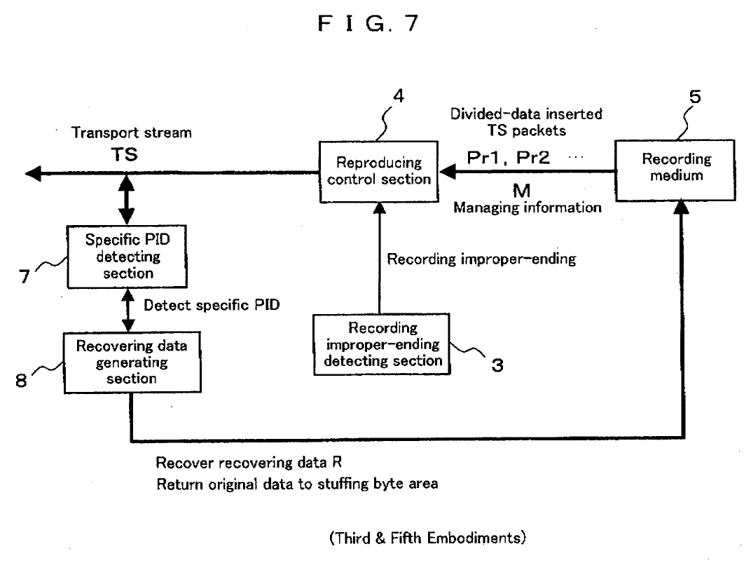

FIG. 7 is a block diagram for showing the structure of a recording and reproducing apparatus according to a third embodiment of the present invention. In this embodiment, at the time of reproducing action, the original recovering data is generated from the divided data, and the managing information is recovered by using the recovering data. At the same time, the data in the stuffing byte area, which has been replaced with the divided data, is restored in its original state.

In FIG. 7, reference numeral 7 is a specific PID detecting section. The specific PID detecting section 7 detects the specific PID in the transport stream that is outputted from the reproducing control section 4. The specific PID herein means a single PID that is specified in advance as the storage packet for the divided data. The specific PID detecting section 7 starts the action upon receiving a recording improper-ending notification. Reference numeral 8 is a recovering data generating section. The recovering data generating section 8 recovers the recovering data R by combining the divided data R1, R2, - - - stored in the stuffing byte areas of a plurality of TS packets Pr1, Pr2, - - - , which correspond to the specific PID that is specified by the specific PID detecting section 7. Further, the recovering data generating section 8 returns the original data to the stuffing byte areas whose data has been replaced with the divided data R1, R2, - - - . Reference numeral 3 is a recording improper-ending detecting section similar to that of the first embodiment. Reference numeral 4 is a reproducing control section similar to that of the first embodiment.

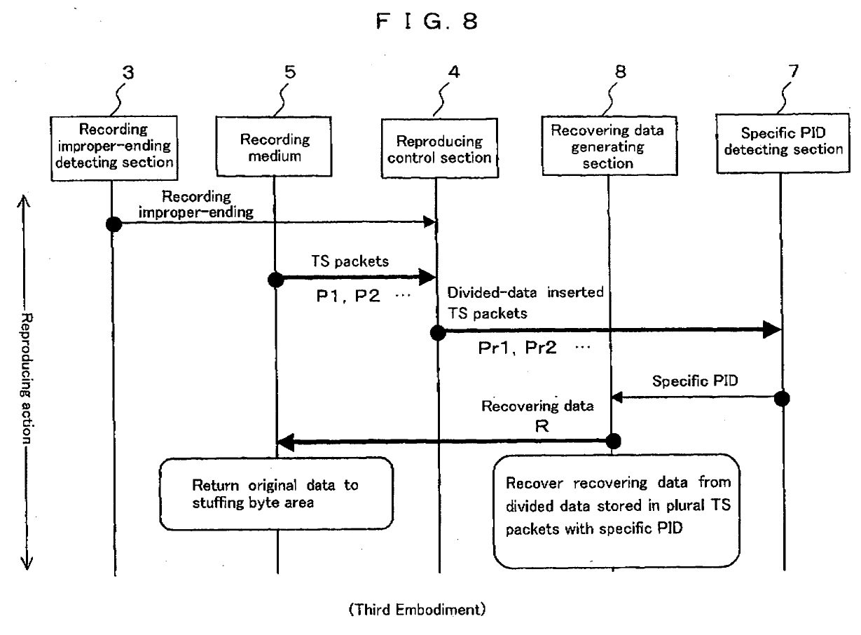

Next, the action of the recording and reproducing apparatus according to the embodiment structured in the manner as described above will be described by referring to the sequence chart shown in FIG. 8. At the time of reproducing action, the reproducing control section 4 reads out the TS packets P and the managing information M thereof from the recording medium 5 in order. The read-out data contains the TS packets Pr1, Pr2, - - - , to which the divided data have been inserted, and the respective managing information M. In this state, the reproducing control section 4 checks whether or not there is a recording improper-ending notification received from the recording improper-ending detecting section 3 and saved. Upon confirming that the notification is saved, the reproducing control section 4 generates the original recovering data R from the divided data R1, R2, - - - , which are read out from a plurality of TS packets Pr1, Pr2, - - - with the specific PID, through the specific PID detecting section 7 and the recovering data generating section 8. That is, the TS packet having the specific PID is detected from a series of TS packets Pr1, Pr2, - - - by the specific PID detecting section 7 that starts the action upon receiving the recording improper-ending notification.

The recovering data generating section 8 recovers the recovering data R by combining the divided data R1, R2, - - - stored in the stuffing byte areas of a plurality of TS packets Pr1, Pr2, - - - , which correspond to the specific PID, The recovering data R that has been recovered to the original state is sent out to the reproducing control section 4. The reproducing control section 4 recovers the managing information M by using the recovering data R when reproducing the TS packets P, and makes an access to the recording medium 5 based on the recovered managing information M to reproduce the TS packets P1, P2, - - - from the recording medium 5. The TS packets P1, P2, - - - reproduced in order are a series of transport streams. Further, the recovering data generating section 8 returns the original data to the stuffing byte areas whose data has been replaced with the divided data R1, R2, - - - , after recovering the recovering data R.

For describing a mode of the action by referring to FIG. 6 mentioned above, the original recovering data R is generated by combining the divided data R1, R2, - - - , which are inserted in the stuffing byte areas of a plurality of TS packets Pr1, Pr2, - - - , which correspond to the same PID (specific PID).

As described above, it is possible with the embodiment to recover the original recovering data by combining the divided data that is recorded in the stiffing byte areas of a plurality of TS packets that correspond to the same PID (specific PID) in the transport stream. Thus, the stuffing byte areas that have been replaced with the divided data can be returned to the original data. Needless to say, like with the first embodiment, it is also possible with the third embodiment to achieve such effects that it requires no nonvolatile memory, is capable of promoting cost down, and capable of utilizing the recording medium without waste.

### Fourth Embodiment

In a fourth embodiment of the present invention, the divided data is individually inserted in the stuffing byte areas of a plurality of TS packets that correspond to a plurality of different specific PIDs that are set in advance, and the TS packets are recorded on the recording medium 5. It is different from the second embodiment in the following respect. In the second embodiment, the specific PID is the same single PID, and the divided data is inserted in a plurality of TS packets that correspond to the specific PID that is defined in that manner. Meanwhile, the specific PIDs in the fourth embodiment are a plurality of PIDs that are different from each other, and the divided data is inserted in a plurality of TS packets that correspond to the specific PIDs defined in that manner. In short, the same single specific PID is defined as the specific PID in the second embodiment, whereas a plurality of different PIDs are defined as the specific PIDs in the fourth embodiment.

The structure of the second embodiment shown in FIG. 4 is quoted for describing the structure of the recording and reproducing apparatus according to the fourth embodiment of the present invention. However, the specific PID detecting section 6 detects the specific PIDs defined as having different PIDs in the inputted transport stream.

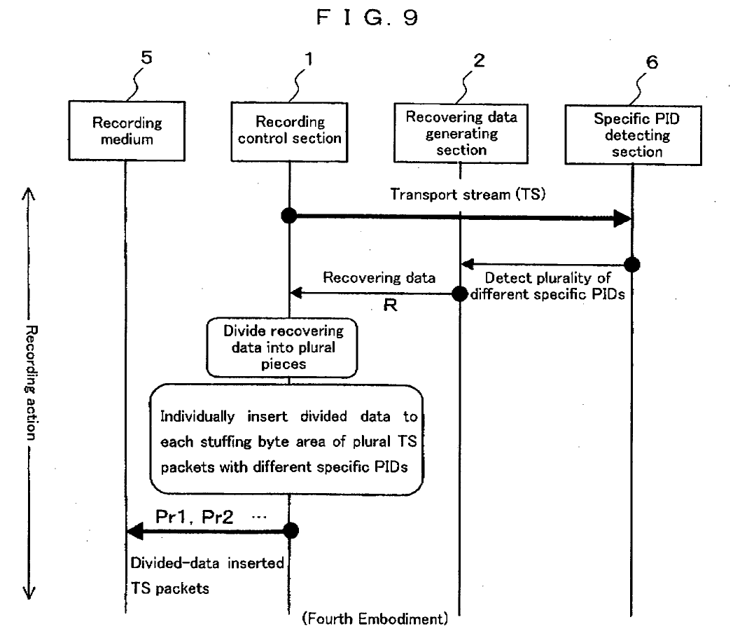

Next, the action of the recording and reproducing apparatus according to the embodiment structured in the manner as described above will be described by referring to the sequence chart shown in FIG. 9. The recording control section 1 generates the managing information M that corresponds to each TS packet P in the transport stream inputted from the outside.

The specific PID detecting section 6 detects a plurality of different specific PIDs in the transport stream inputted to the recording control section 1, and notifies the recording control section 1 through the recovering data generating section 2 that the specific PIDs are detected. As a preliminary measure for the case where the recording is ended improperly, the recovering data generating section 2 generates the recovering data R that is required for recovering from the abnormality, and sends it out to the recording control section 1.

The recording control section 1 generates the divided data R1, R2, - - - by dividing the recovering data R received from the recovering data generating section 2 into a plurality of pieces. Then, the recording control section 1 individually inserts the generated divided data R1, R2, - - - in each of the stuffing byte areas in a plurality of TS packets P1′, P2′, - - - , which correspond to the specific PIDs (whose PIDs are different from each other). Further, the recording control section 1 records the TS packets Pr1′, Pr2′, - - - , in which the divided data has been inserted, on the recording medium 5 in order along with the respective managing information M.

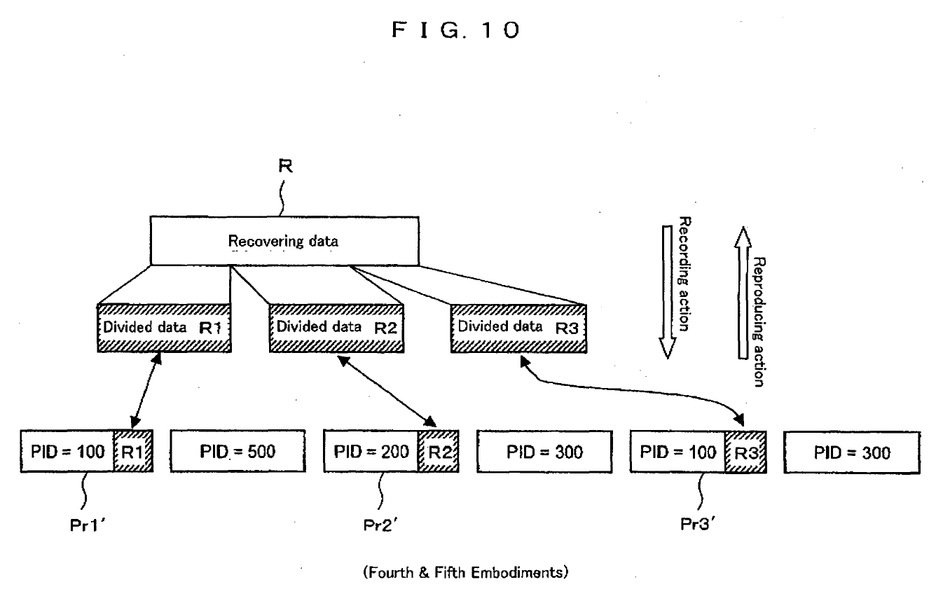

FIG. 10 shows a mode of the action. The divided data R1, R2, - - - obtained by dividing the recovering data R into a plurality of pieces are inserted in the stuffing byte areas of the TS packets Pr1′, Pr2′, - - - with a plurality of different specific PIDs. The divided data R1 is inserted to the TS packet Pr1′ with PID=100, the divided data R2 is inserted to the TS packet Pr2′ with PID=200, and the divided data R3 is inserted to the TS packet Pr3′ with PID=100.

As described above, in this embodiment, the divided data that is obtained by dividing the recovering data R into a plurality of pieces is individually inserted in each stuffing byte area of a plurality of TS packets that correspond to a plurality of different specific PIDs. Then, the PS packets in that state are recorded on the recording medium 5 in order. Needless to say, like with the first embodiment, it is also possible with the fourth embodiment to achieve such effects that it requires no nonvolatile memory, is capable of promoting cost reduction, and capable of utilizing the recording medium 5 without waste.

### Fifth Embodiment

In a fifth embodiment of the present invention, the managing information is recovered by detecting a plurality of PIDs in which the recovering data for reproducing the TS packets is recorded. FIG. 7 of the third embodiment is quoted for describing the recording and reproducing apparatus according to the fifth embodiment of the present invention. However, the specific PID detecting section 7 detects a group of specific PIDs having PIDs that are different from each other in the transport stream that is reproduced and outputted.

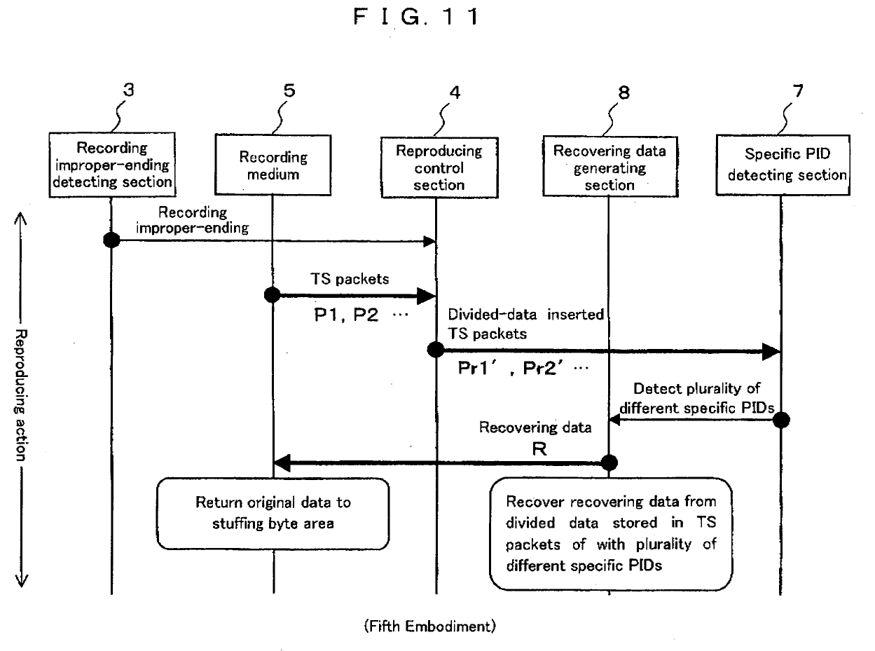

Next, the action of the recording and reproducing apparatus according to the embodiment structured in the manner as described above will be described by referring to the sequence chart shown in FIG. 11. At the time of reproducing action, the reproducing control section 4 reads out the TS packets P and the managing information M from the recording medium 5. The read-out data contains the TS packets Pr1′, Pr2′, - - - , in which the divided data has been inserted, and their respective managing information M.

At the time of readout action, the reproducing control section 4 checks whether or not there is a recording improper-ending notification received from the recording improper-ending detecting section 3 and saved. Upon confirming that the notification is saved, the reproducing control section 4 starts the functions of the specific PID detecting section 7 and the recovering data generating section 8 to recover the original recovering data R from the divided data R1′, R2′, - - - , which are stored in the TS packets Pr1′, Pr2′, - - - defined by a plurality of specific PIDs whose PIDs are different from each other.

More specifically, it can be described as follows. The specific PID detecting section 7 that starts the action upon receiving a recording improper-ending notification detects the specific PIDs (whose PIDs are different from each other) in which the divided data is stored, from a series of TS packets Pr1′, Pr2′, - - - . The recovering data generating section 8 recovers the original recovering data R by combining the divided data R1′, R2′, - - - from the stuffing byte areas of the TS packets Pr1′, Pr2′, - - - , which correspond to the detected specific PIDs.

The recovering data R that has been recovered to the original state is sent out to the reproducing control section 4. The reproducing control section 4 recovers the managing information M by using the recovering data R when reproducing the TS packets P, and makes an access to the recording medium 5 based on the recovered managing information M to reproduce the TS packets P1, P2, - - - from the recording medium 5. The TS packets P1, P2, - - - reproduced in order are a series of transport streams. Further, the recovering data generating section 8 returns the original data to the stuffing byte areas whose data has been replaced with the divided data R1, R2, - - - , after recovering the recovering data R.

FIG. 10 shows a mode of the action. The original recovering data R is generated by combining the divided data R1, R2, - - - , which are inserted in the stuffing byte areas of a plurality of TS packets Pr1′, Pr2′, - - - , which correspond to a plurality of PIDs (whose PIDs are different from each other).

As described above, it is possible with the embodiment to generate the recovering data by combining the divided data that is recorded in the stuffing byte areas of a plurality of TS packets that correspond to a plurality of specific PIDs (whose PIDs are different from each other) in the transport stream. Thus, the data in the stuffing byte areas, which has been replaced with the divided data, can be restored in its original state. Needless to say, like with the first embodiment, it is also possible with the fifth embodiment to achieve such effects that it requires no nonvolatile memory, is capable of promoting cost reduction, and capable of utilizing the recording medium without waste.

### Sixth Embodiment

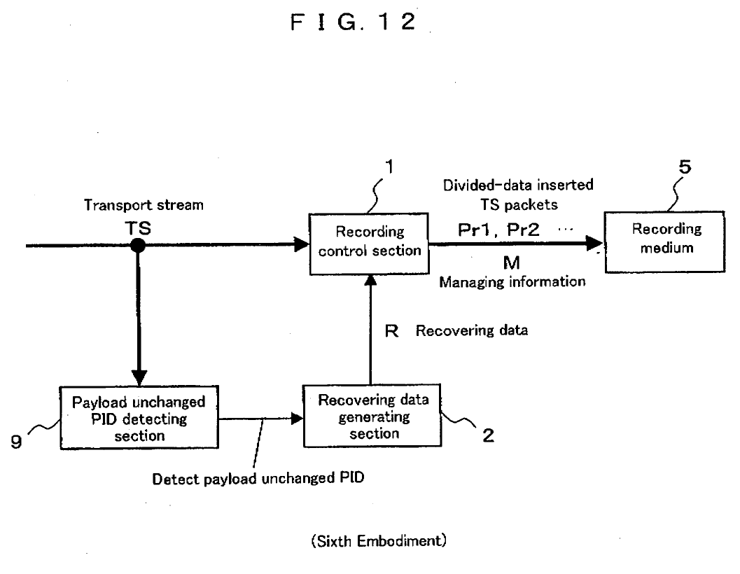

FIG. 12 is a block diagram for showing the structure of the recording and reproducing apparatus according to a sixth embodiment of the present invention. In this embodiment, the managing information is recovered by recording the recovering data in a payload of the TS packet whose payload is unchanged.

In FIG. 12, reference numeral 9 is a payload unchanged PID detecting section. The payload unchanged PID detecting section 9 detects, in the transport stream that is inputted into the recording control section 1, the PID of the TS packets whose payload is unchanged. Reference numeral 1 is a recording control section similar to that of the first embodiment, and reference numeral 2 is a recovering data generating section similar to that of the first embodiment.

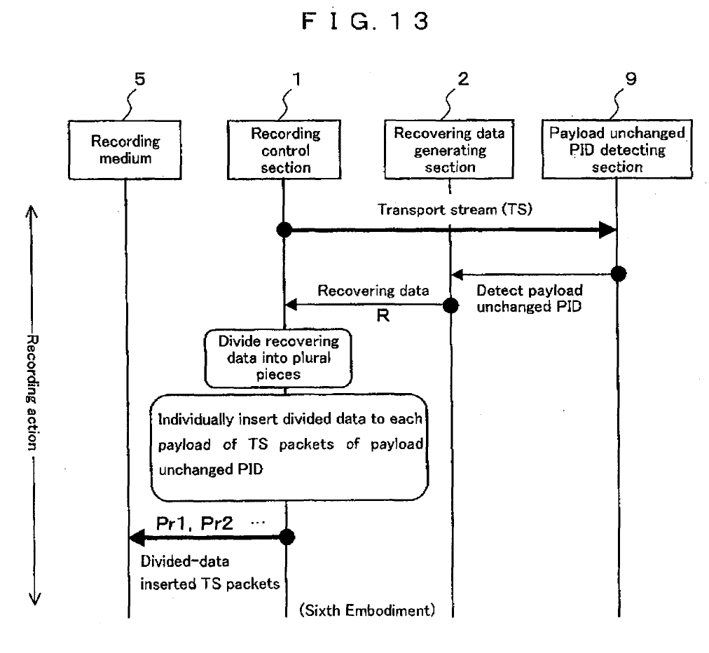

Next, the action of the recording and reproducing apparatus according to the embodiment structured in the manner as described above will be described by referring to the sequence chart shown in FIG. 13. The payload unchanged PID detecting section 9 monitors whether or not a PID having no change in the data of the payload is in the transport stream that is inputted into the recording control section 1. Upon detecting the PID having no change in the data of the payload, the payload unchanged PID detecting section 9 notifies the recording control section 1 through the recovering data generating section 2 that it has detected the payload unchanged PID. As a preliminary measure for the case where the recording action is improperly ended, the recovering data generating section 2 generates the recovering data R that is required for recovering from the abnormality, and sends it out to the recording control section 1.

The recording control section 1 generates the divided data R1, R2, - - - by dividing the recovering data R received from the recovering data generating section 2 into a plurality of pieces. Then, the recording control section 1 individually inserts the generated divided data R1, R2, - - - in each of the payloads of a plurality of TS packets P1, P2, - - - , which correspond to the PID that is detected as a payload unchanged PID. Further, the recording control section 1 records the TS packets Pr1, Pr2, - - - , in which the divided data has been inserted, on the recording medium 5 in order along with the respective managing information M.

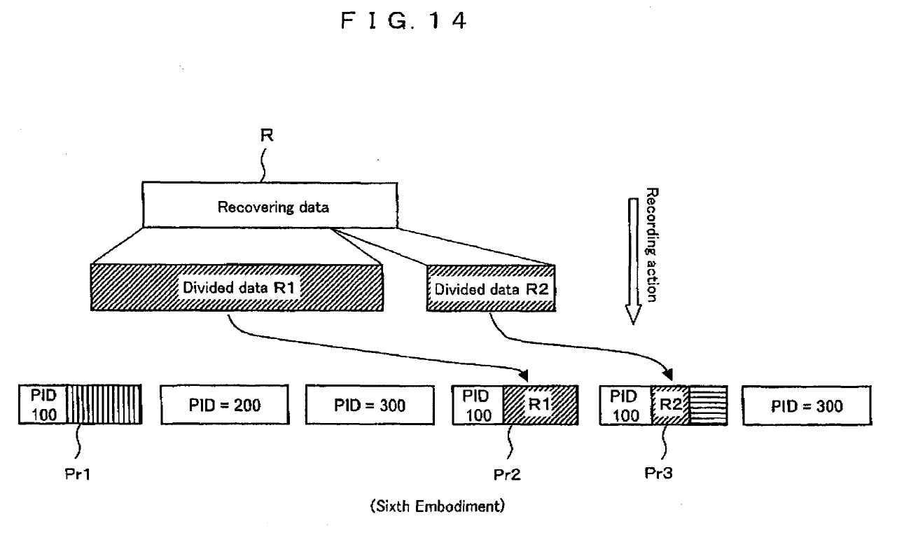

FIG. 14 shows a mode of the action. The divided data R1, R2, - - - obtained by dividing the recovering data into a plurality of pieces are inserted in the payloads of a plurality of TS packets Pr1, Pr2, - - - with the specific PID (PID=100).

As described above, it is possible with the embodiment to individually insert the divided data, which is obtained by dividing the recovering data into a plurality of pieces, in each of the payloads of a plurality of the TS packets that correspond to the payload unchanged PID, and records the TS packets in that state on the recording medium 5 in order. Needless to say, like with the first embodiment, it is also possible with the sixth embodiment to achieve such effects that it requires no nonvolatile memory, is capable of promoting cost reduction, and capable of utilizing the recording medium without waste.

### Seventh Embodiment

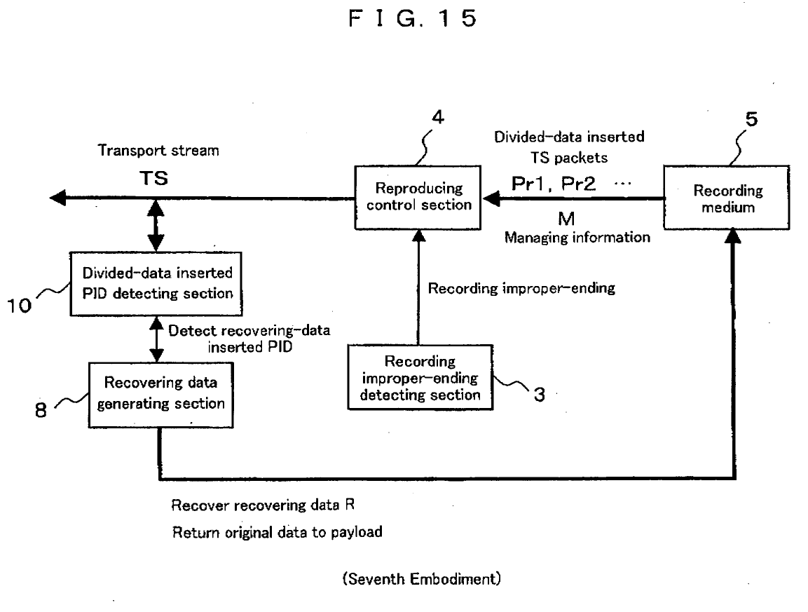

FIG. 15 is a block diagram for showing the structure of the recording and reproducing apparatus according to a seventh embodiment of the present invention. In this embodiment, the managing information is recovered by detecting, in the reproduced transport stream, the PID of the PS packets having the divided data R1, R2, - - - recorded in the payloads. In FIG. 15, reference numeral 10 is a divided-data inserted PID detecting section. The divided-data inserted PID detecting section 10 detects, in the MPEG transport stream, the PID of the TS packets P that have the divided data R1, R2, - - - inserted in the payloads. Reference numeral 3 is a recording improper-ending detecting section similar to that of the first embodiment. Reference numeral 4 is a reproducing control section similar to that of the first embodiment. Reference numeral 8 is a recovering data generating section similar to that of the third embodiment. However, the recovering data generating section 8 recovers the recovering data R by combining the divided data R1, R2, - - - stored in the payloads of a plurality of TS packets Pr1, Pr2, - - - , which correspond to the PID detected by the divided-data inserted PID detecting section 10. Further, the recovering data generating section 8 returns the original data to the payloads whose data has been replaced with the divided data R1, R2, - - - .

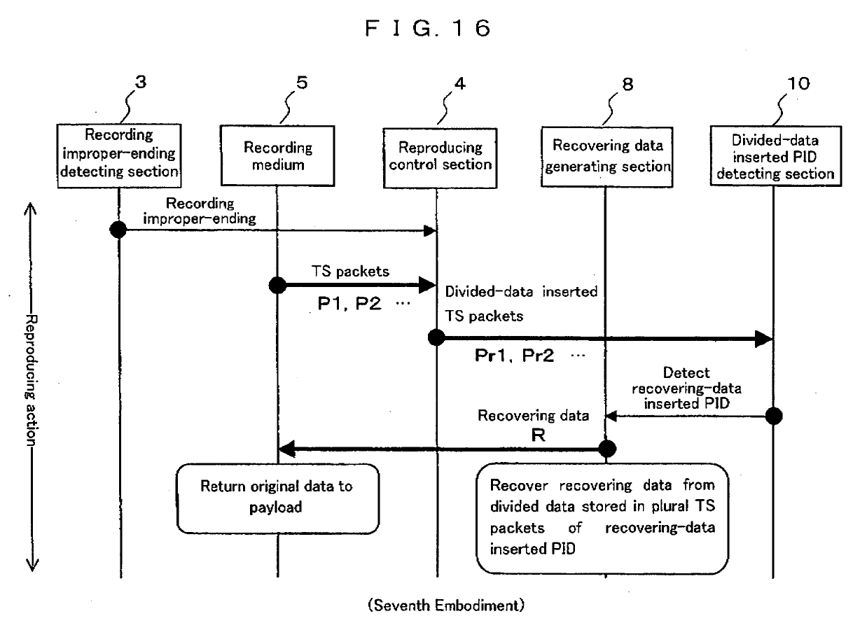

Next, the action of the recording and reproducing apparatus according to the embodiment structured in the manner as described above will be described by referring to the sequence chart shown in FIG. 16. At the time of reproducing action, the reproducing control section 4 reads out the TS packets P and the managing information M thereof from the recording medium 5 in order. The read-out data contains the TS packets Pr1, Pr2, - - - having the divided data R1, R2, - - - inserted in the payloads, and their respective managing information M.

At the time of readout action, the reproducing control section 4 checks whether or not there is a recording improper-ending notification received from the recording improper-ending detecting section 3 and saved. Upon confirming that the notification is saved, the reproducing control section 4 starts the functions of the divided-data inserted PID detecting section 10 and the recovering data generating section 8 to recover the original recovering data R from the divided data R1, R2, - - - , which are stored in the payloads of a plurality of TS packets Pr1, Pr2, - - - .

More specifically, it can be described as follows. That is, the TS packets having the divided data inserted to the payloads are detected from a series of TS packets Pr1, P-2, - - - by the divided-data inserted PID detecting section 10 that starts the action upon receiving the recording improper-ending notification. Detection of the payload inserted PID can be performed as follows, for example. That is, after completing the sections such as PAT or PMT that is required at the time of recording, the PID of packet whose TS packet or payload has the recovering data recorded therein, is detected as the PID in which the recovering data is inserted (payload inserted PID). The recovering data generating section 8 recovers the recovering data R by combining the divided data R1, R2, - - - stored in the payloads of the TS packets Pr1, Pr2, - - - , which correspond to the detected PID.

The recovering data R that has been recovered to the original state is sent out to the reproducing control section 4. The reproducing control section 4 recovers the managing information M by using the recovering data R when reproducing the TS packets P, and makes an access to the recording medium 5 based on the recovered managing information M to reproduce the TS packets P1, P2, - - - from the recording medium 5. The TS packets P1, P2, - - - reproduced in order are a series of transport streams. Further, the recovering data generating section 8 returns the original data to the payloads whose data has been replaced with the divided data R1, R2, - - - , after recovering the recovering data R.

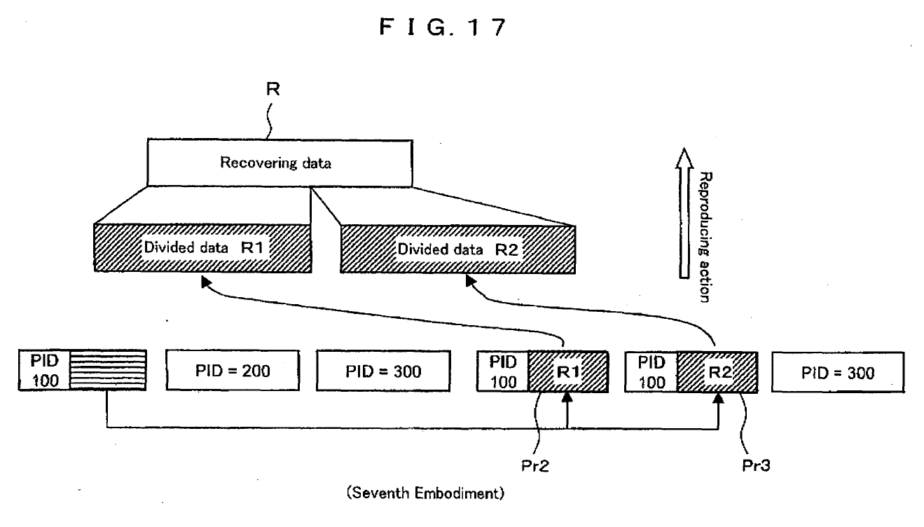

FIG. 17 shows a mode of the action. The original recovering data R is generated by combining the divided data R1, R2, - - - , which are inserted in the payloads of a plurality of TS packets Pr1, Pr2, - - - .

As described above, it is possible with the embodiment to recover the original recovering data by combining the divided data that is recorded in the payloads of the transport stream, and then return the original data to the payloads whose data has been replaced with the divided data.

### Eighth Embodiment

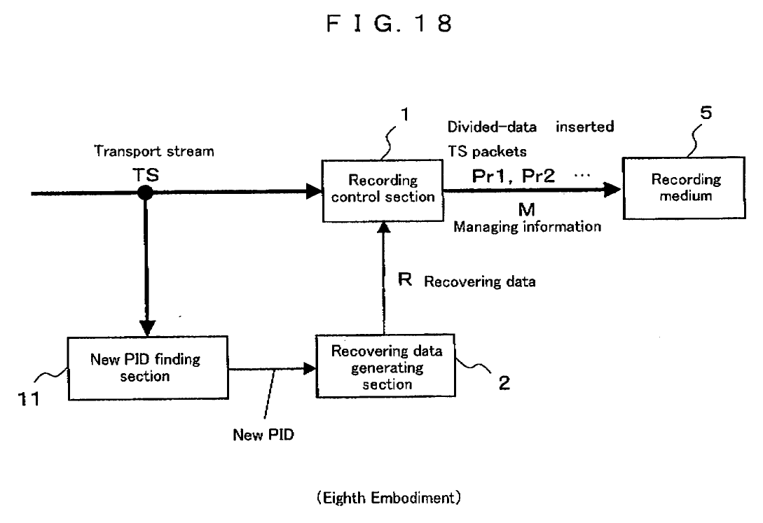

FIG. 18 is a block diagram for showing the structure of the recording and reproducing apparatus according to an eighth embodiment of the present invention. In this embodiment, the managing information is recovered by generating an additional PID for inserting the recovering data of the TS packet to be recorded.

In FIG. 18, reference numeral 11 is a new PID finding section. The new PID finding section 11 finds a new PID by excluding the PIDs in the inputted transport stream. Reference numeral 1 is a recording control section similar to those described above, and 2 is a recovering data generating section similar to those described above.

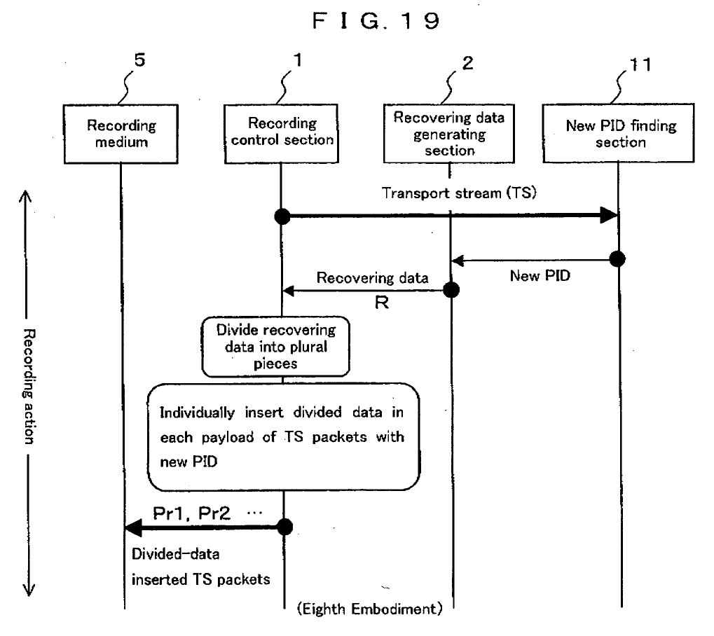

Next, the action of the recording and reproducing apparatus according to the embodiment structured in the manner as described above will be described by referring to the sequence chart shown in FIG. 19. The new PID finding section 11 finds a new PID by excluding the PIDs in the transport stream inputted into the recording control section, and sends out the found new PID to the recording control section 1 through the recovering data generating section 2. The recovering data generating section 2 generates the recovering data R and sends it out to the recording control section 1.

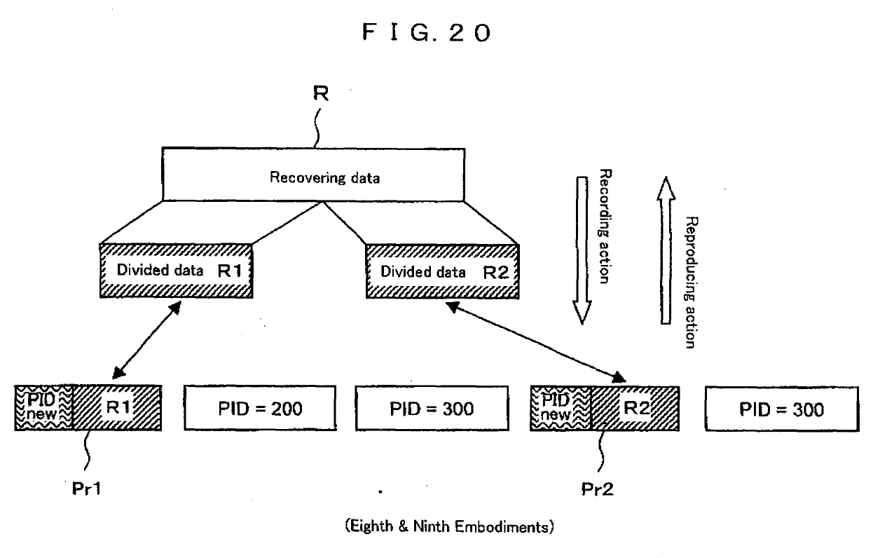

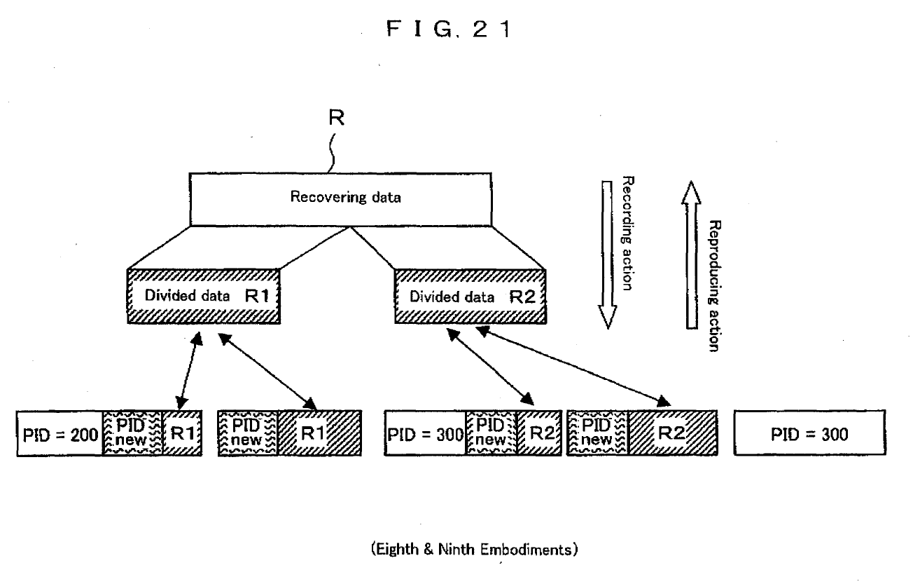

The recording control section 1 generates a plurality of TS packets Pr1, Pr2, - - - with the new PID. At the same time, the recording control section 1 generates the divided data R1, R2, - - - obtained by dividing the recovering data R received from the recovering data generating section 2 into a plurality of pieces, and individually inserts the generated divided data R1, R2, - - - in a plurality of TS packets Pr1, Pr2, - - - , which correspond to the new PID. Further, the recording control section 1 records the TS packets Pr1, Pr2, - - - , in which the divided data has been inserted, on the recording medium 5 along with the respective managing information M. FIG. 20 and FIG. 21 show the modes of the action.

As described above, it is possible with the embodiment to generate a plurality of TS packets with a new PID that is not in the transport stream, and record the TS packets with the divided data inserted therein on the recording medium 5.

### Ninth Embodiment

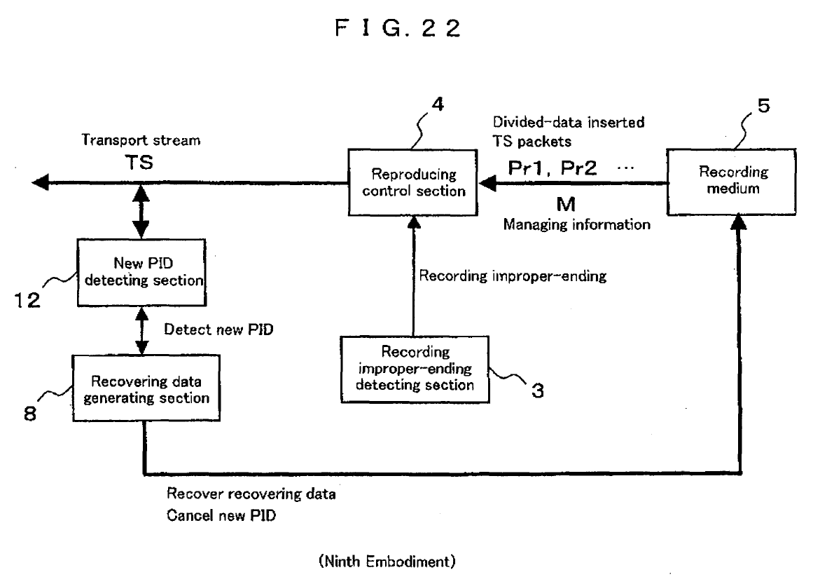

FIG. 22 is a block diagram for showing the structure of the recording and reproducing apparatus according to a ninth embodiment of the present invention. In this embodiment, the managing information is recovered by detecting the new PID in which the recovering data in the TS packet P to be reproduced is recorded.

In FIG. 22, reference numeral 12 is a new PID detecting section for detecting the new PID. Reference numeral 3 is a recording improper-ending detecting section similar to that of the eighth embodiment. Reference numeral 4 is a reproducing control section similar to that of the eighth embodiment. Reference numeral 8 is a recovering data generating section similar to that of the eighth embodiment.

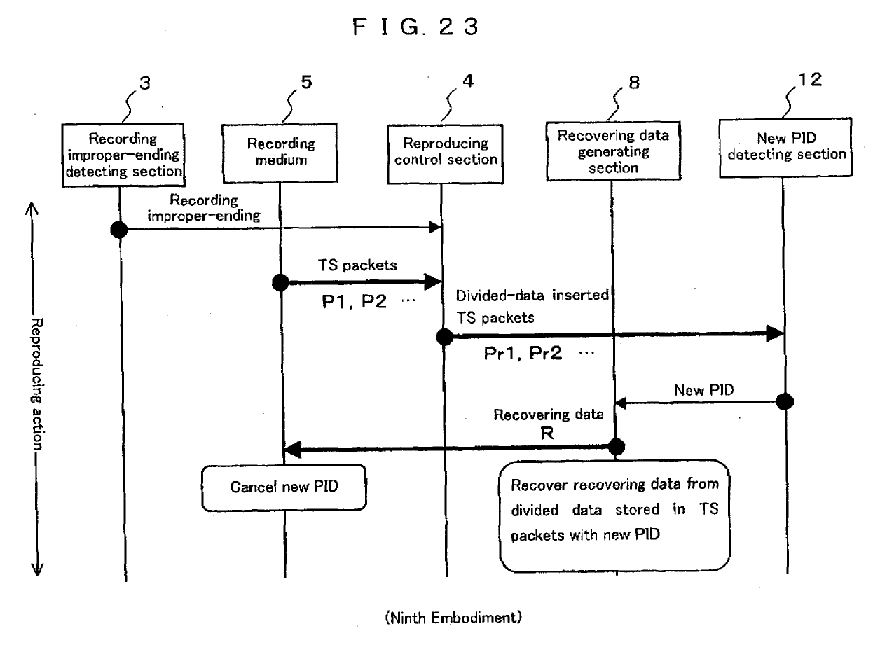

Next, the action of the recording and reproducing apparatus according to the embodiment structured in the manner as described above will be described by referring to the sequence chart shown in FIG. 23. At the time of reproducing action, the reproducing control section 4 reads out the TS packets P and the managing information M from the recording medium 5 in order. The read-out data contains the TS packets Pr1, Pr2, - - - , having the divided data R1, R2, - - - inserted in the payloads, and the respective managing information M.

At the time of readout action, the reproducing control section 4 checks whether or not there is a recording improper-ending notification received from the recording improper-ending detecting section 3 and saved. Upon confirming that the notification is being received, the reproducing control section 4 starts the functions of the new PID detecting section 12 and the recovering data generating section 8 to recover the original recovering data R from the divided data R1, R2, - - - , which are stored in the TS packets Pr1, Pr2, - - - with the new PID.

More specifically, it can be described as follows. That is, the new PID detecting section 12 that starts the action upon receiving the recording improper-ending notification detects the new PID from a series of the TS packets Pr1, Pr2, - - - . The recovering data generating section 8 recovers the recovering data R by combining the divided data R1, R2, - - - stored in the payloads of the TS packets Pr1, Pr2, - - - , which correspond to the detected new PID.

The recovering data R that has been recovered to the original state is sent out to the reproducing control section 4. The reproducing control section 4 recovers the managing information M by using the recovering data R when reproducing the TS packets P, and makes an access to the recording medium 5 based on the recovered managing information M to reproduce the TS packets P1, P2, - - - from the recording medium 5. The TS packets P1, P2, - - - reproduced in order are a series of transport streams. Further, the recovering data generating section 8 cancels the new PID after recovering the recovering data R. The modes of the action are shown in FIG. 20 and FIG. 21.

As described above, it is possible with the embodiment to recover the recovering data from the divided data recorded in the new PID that is provided in the transport stream, and cancel the PID for the recovering data thereafter.

The present invention has been described in detail by referring to the most preferred embodiments. However, various combinations and modifications of the components are possible without departing from the spirit and the broad scope of the appended claims.

What is claimed is:

1. A recording and reproducing apparatus, wherein:
managing information and recovering data for a TS packet is inserted in said TS packet of a recording-target transport stream, and said TS packet is recorded on a recording medium; and
at a time of reproducing action performed after recording halt processing is not properly ended, said recovering data is extracted from a TS packet that is read out from said recording medium, said managing information is recovered from said recovering data that has been extracted, and said TS packet is reproduced from said recording medium based on said managing information that has been recovered.

2. The recording and reproducing apparatus according to claim 1, comprising:
a recovering data generating section for generating said recovering data at a time of recording action;
a recording control section which generates said managing information of said TS packet of said recording-ta-get transport stream, inserts said recovering data in said TS packet, and records a recovering-data inserted TS packet on said recording medium along with said managing information;
a recording improper-ending detecting section which, upon detecting that recording halt processing is not properly ended, sends out a recording improper-ending notification to said recording control section; and
a reproducing control section which reads out said managing information from said recording medium, and reproduces said TS packet by making an access to said recording medium based on said managing information, wherein
upon receiving said recording improper-ending notification from said recording improper-ending detecting section, said reproducing control section reads out said recovering-data inserted TS packet from said recording medium and extracts said recovering data from said TS packet, recovers said managing information form said recovering data that has been extracted, and reproduces said TS packet from said recording medium based on said managing information that has been recovered.

3. The recording and reproducing apparatus according to claim 2, wherein said recording control section inserts said recovering data in a stuffing byte area of said TS packet.

4. The recording and reproducing apparatus according to claim 2, further comprising a specific PID detecting section for detecting a preset specific PID from said recording-target transport stream, wherein
upon receiving a detection notification of said specific PID from said PID detecting section, said recording control section generates divided data that is obtained by dividing said recovering data into a plurality of pieces, individually inserts said divided data to a plurality of specific TS packets that correspond to said specific PID, and records said divided-data inserted specific TS packets on said recording medium along with said managing information.

5. The recording and reproducing apparatus according to claim 4, wherein:
upon receiving said recording improper-ending notification from said recording improper-ending detecting section, said specific PID detecting section detects said specific PID from said transport stream that is read out from said recording medium;
at a time of reproducing action performed after receiving said recording improper-ending notification, said recovering data generating section extracts said divided data from each of said plurality of TS packets that correspond to said specific PID, and recovers said recovering data by combining a plurality of pieces of said divided data that have been extracted; and
said reproducing control section recovers said managing information by using said recovering data that has been recovered.

6. The recording and reproducing apparatus according to claim 4, wherein said recovering data generating section returns the original data to said TS packets whose data has been replaced with said divided data.

7. The recording and reproducing apparatus according to claim 4, wherein said specific PID detecting section sets the same PID as said specific PID.

8. The recording and reproducing apparatus according to claim 4, wherein said specific PID detecting section sets a plurality of PIDs that are different from each other as said specific PID.

9. The recording and reproducing apparatus according to claim 2, further comprising a payload unchanged PID detecting section which detects, in said recording-target transport stream, a payload unchanged PID that corresponds to a TS packet whose payload is unchanged, wherein
upon receiving a detection notification of said payload unchanged PID from said payload unchanged PID detecting section, said recording control section generates divided data that is obtained by dividing said recovering data into a plurality of pieces, individually inserts said divided data to each payload of a plurality of said specific TS packets that correspond to said payload unchanged PID, and records divided-data inserted specific TS packets on said recording medium along with said managing information.

10. The recording and reproducing apparatus according to claim 9, further comprising a divided-data inserted PID detecting section which detects, in a transport stream that is reproduced from said recording medium, divided-data inserted PIDs that correspond to said divided-data inserted TS packets, wherein
upon receiving said recording improper-ending notification from said recording improper-ending detecting section, said recovering data generating section extracts said divided data from each of said payloads of said TS packets that correspond to said divided-data inserted PIDs detected by said divided-data inserted PID detecting section, and recovers said recovering data from a plurality of pieces of said divided data that have been extracted.

11. The recording and reproducing apparatus according to claim 10, wherein said recovering data generating section returns the original data to said payloads whose data has been replaced with said divided data.

12. The recording and reproducing apparatus according to claim 6, further comprising a new PID finding section which finds a new PID that is not currently present in said recording-target transport stream, wherein
upon receiving a detection notification of said new PID from said new PID finding section, said recording control section generates divided data that is obtained by dividing said recovering data into a plurality of pieces, individually inserts said divided data in each payload of a plurality of said TS packets that correspond to said new PID, and records said divided data inserted specific TS packets on said recording medium along with said managing information.

13. The recording and reproducing apparatus according to claim 12, further comprising a new PID detecting section which detects said new PID in a transport stream that is reproduced from said recording medium, wherein
upon receiving said recording improper-ending notification, said recovering data generating section extracts said divided data from each of said payloads of said TS packets that correspond to said new PID detected by said new PID detecting section, and recovers said recovering data from a plurality of pieces of said divided data that have been extracted.

14. The recording and reproducing apparatus according to claim 13, wherein said recovering data generating section returns the original data to said payloads whose data has been replaced with said divided data.
